(19) United States
(12) Patent Application Publication
(10) Pub. No.: US 2017/0323056 A1
(43) Pub. Date: Nov. 9, 2017

(54) PATIENT CARE RECORD CONVEYANCE

(71) Applicant: Sphere3, LLC, Kansas City, KS (US)

(72) Inventors: Kourtney Govro, Raymore, MO (US); Rodney Corn, Anthem, AZ (US); Kristal Rayson, Independence, MO (US); Steven Kent Mills, Overland Park, KS (US)

(21) Appl. No.: 15/585,307

(22) Filed: May 3, 2017

Related U.S. Application Data
(60) Provisional application No. 62/331,059, filed on May 3, 2016.

(51) Int. Cl. G06F 19/00; H04L 29/06

(52) U.S. Cl. CPC G06F 19/322; H04L 63/0853

(57) ABSTRACT

Media, method, and system are described for creating and operating software capable of performing steps to capture, collect, analyze, transfer, and present patient care information recorded in a patient care record. Particularly, mobile electronic devices of patients may be leveraged to support transfer of care data records from one care location to another.

### RELATED APPLICATIONS

This non-provisional patent application claims priority benefit, with regard to all common subject matter, of earlier-filed U.S. Provisional Patent Application No. 62/331,059, filed May 3, 2016, and entitled SYSTEMS AND METHODS OF MODELING PATIENT BEHAVIORS TO PREDICT AND INCREASE SATISFACTION. The identified earlier-filed provisional patent application is hereby incorporated by reference in its entirety into the present application.

This non-provisional patent application discloses subject matter that integrates with subject matter disclosed in U.S. patent application Ser. No. 13/795,501, filed Mar. 12, 2013, and entitled SYSTEMS AND MODULES FOR IMPROVING PATIENT SATISFACTION. The identified earlier-filed patent application is hereby incorporated by reference in its entirety into the present application.

### BACKGROUND

### 1. Field

Embodiments of the invention are broadly directed to methods and systems for generating, retrieving, transmitting, and updating patient care records. Specifically, embodiments of the invention establish unique correlations linking a record containing patient care data and the identity of a particular patient so that the record may travel with the patient to care facilities and other locations that may not otherwise share data with the original data-collecting care facility.

### 2. Related Art

Traditionally, access to a patient care record is often restricted to the locations at which the care was documented. Patient care and satisfaction can be improved when patient care records can be shared across all locations, establishments, departments, and facilities that provide care to a particular patient. Further, record sharing increases patient safety, reduces errors, and saves valuable time when the need to redocument information is obviated.

Securely and accurately sharing patient care data is often difficult to achieve, due to challenges posed by identity ambiguity and rules regulating the transfer of patient care data. Failure to retrieve a patient's record can lead to severe dissatisfaction from the patient with both the original care facility and the facility seeking to receive the record. Further, a patient care record may be attributed to the wrong patient with disastrous health and legal consequences. Accordingly, there is a need for improved systems and methodologies to correlate patient records with a patient's identity in a robust, secure manner that enables the patient access to their record throughout their life.

### SUMMARY

Embodiments of the invention address this need by generating and maintaining patient care records in a server that may be remotely accessed. Embodiments of the invention may further include steps of generating unique indicia and correlating them to the patient care records to enable reliable, secure retrieval. Embodiments of the invention include various systems and methods for generating, correlating, and presenting indicia that support a request for a patient care record at a current patient care location, regardless of its relation to a previous patient care location.

In a first embodiment, a system for managing patient care data includes one or more electronic care devices such as a medical instrument or laptop computer. The electronic care devices are configured to collect and store patient care data in a patient care record on a server, which is then uniquely correlated with an indicium. The computing terminal includes a scanning device for capturing the indicium from a patient's mobile electronic device, which is then used to request the patient care record from the server.

In a second embodiment, a method of managing patient care data begins with collecting patient care data from an electronic care device and recording it in a care record stored on a server. Both the electronic care device and the server are on a local network. The server or a managing processor correlates a unique indicium to the patient care record and transmits the indicium to a mobile electronic device of the patient. Next, the indicium is captured from the mobile electronic device at a computing terminal external to the network and a request is transmitted to the server based at least in part on the unique indicium. The patient may additionally be required to provide an authentication key with the indicium to enable the transmission of the patient care record. In some cases, the indicium may be uncorrelated from the patient care record after expiration of a period of time or threshold number of requests.

In a third embodiment, a system for managing patient care data includes a processor, a network interface card, an indicium receiver, and a non-transitory computer readable medium. The computer readable medium stores computer-executable instructions which, when executed by the processor, perform the steps of capturing an indicium via the indicium receiver, transmitting, via the network interface card, a request based at least in part on the indicium to a server containing the patient care record, and receiving the care record of the patient from the server. After receiving the patient care record, at least a portion of the record may be added or updated and transmitted back to the server.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform for certain embodiments of the invention;

FIG. 2 depicts storage and sharing of patient care records across multiple patient care locations;

FIG. 3 depicts an example of an indicium that may be presented on an electronic device in embodiments of the invention;

FIG. 4 depicts a first flowchart illustrating the operation of a method in accordance with an embodiment of the invention;

FIG. 5 depicts a second flowchart illustrating the operation of a method in accordance with an embodiment of the invention; and

FIG. 6 depicts a third flowchart illustrating the operation of a method in accordance with an embodiment of the invention.

The drawing figures do not limit the invention to the specific embodiments disclosed and described herein. The drawings are not necessarily to scale, emphasis instead being placed upon clearly illustrating the principles of the invention.

### DETAILED DESCRIPTION

Embodiments of the invention are directed to systems and methods for managing patient care data. Patient care data may include medical information such as medical history data, physical measurements such as weight or blood pressure, recorded health parameters such as allergies, medication history, physician's notes, conditions, or any other medical data that may be stored in an electronic medical record (EMR). These examples are not intended as limiting. Any data relevant to prior, current, or future care and well-being of a patient may be included as patient care data in embodiments of the invention.

Traditionally, as discussed above, patient care data is available only to users of computing devices operating on the same local network on which the care data was originally captured and recorded. In cases where the care data is available at other locations, request and retrieval of the appropriate record can be tedious, time-consuming, and error-prone.

Embodiments of the invention first address these issues by correlating each patient care record with a unique indicium such as an alphanumeric string, network address, and/or barcode, which can then be transmitted to the patient. The indicium may be transmitted using a communication technique such as via a Bluetooth connection, an infrared connection, a text message, or an email to a mobile electronic device of the patient such as a mobile phone, laptop computer, or gaming device. In embodiments, the indicium is then captured from the patient's mobile electronic device at a second location, such as an outpatient care facility or patient's home, to enable quick and reliable access to the record without using personally identifiable information, such as a social security number. This description is intended as an example of embodiments of the invention, and is not intended to be limiting. Embodiments of the invention may be applied in any situation in which records need to be retrieved and shared between locations accurately and securely.

The subject matter of embodiments of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be obvious to one skilled in the art, and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments, but is not necessarily included. Thus, the technology can include a variety of combinations and/or integrations of the embodiments described herein.

### Operational Environment for Embodiments of the Invention

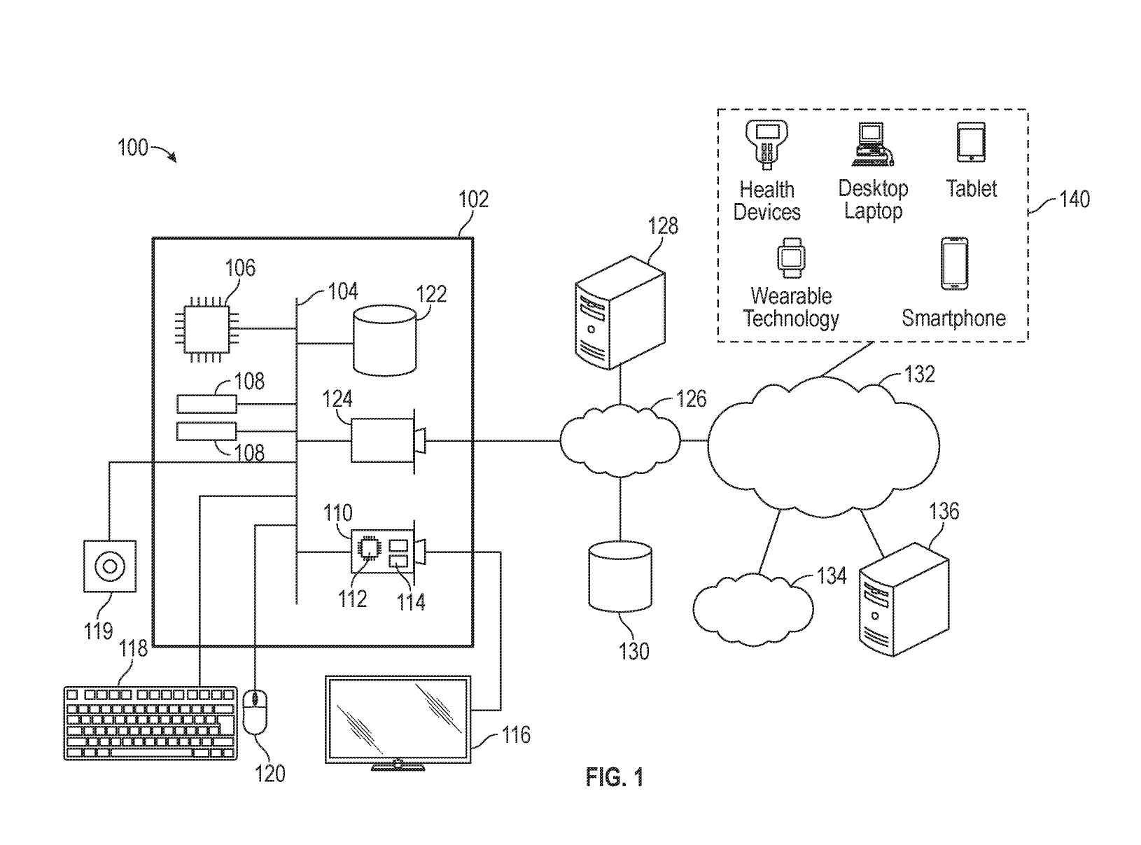

Turning first to FIG. 1, an exemplary hardware platform that can form one element of certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules. Also attached to system bus 104 is graphics card 110. In some embodiments, graphics card 104 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118, indicium receiver 119, and mouse 120 are connected to system bus 104. Like display 116, these peripherals may be integrated into computer 102 or absent. In some embodiments, indicium receiver 119 may be a digital camera, barcode reader, or hardware supporting short-range wireless communication such as RFID, Bluetooth, or infrared (IR) beam communication. Also connected to system bus 104 is local storage 122, which may be any form of computer-readable media, and may be internally installed in computer 102 or externally and removeably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as server 130.

Generally, a data store such as server 130 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132. Through connection 132, the system may be communicatively coupled to devices, wearables, appliances, facility structures, and other electronic care documentation devices, represented in FIG. 1 by element 140.

Embodiments of the invention include systems and methods linking patient care data stored in records to the identity of a particular patient, so that it may travel with the patient to care facilities that may not otherwise share data with the original data-collecting care facility.

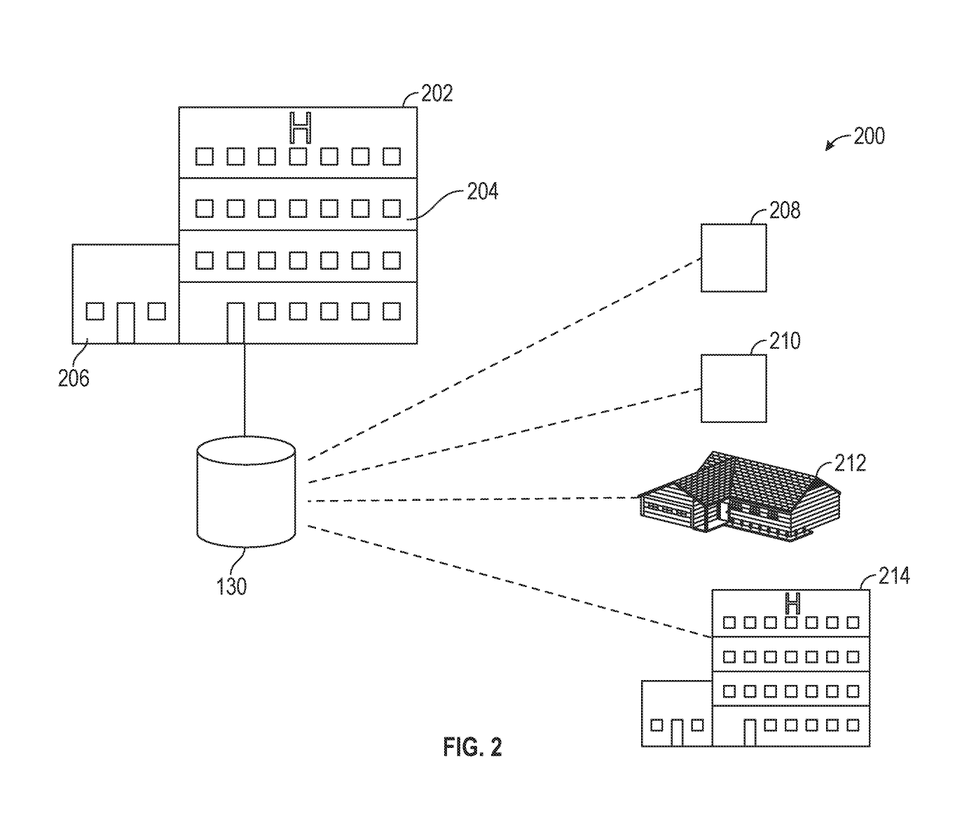

As an example, consider the case of patient care data documented on a floor 204 at a first hospital 202, as illustrated in FIG. 2. During the patient's stay on floor 204, data relating to patient health, behavior, and satisfaction is collected in a wide variety of ways. Some patient care data may be manually entered by the patient or a care provider via a workstation, internet web portal, kiosk, application running on a wireless device, or other manual method. Additionally, data may be pulled automatically from previous electronic medical records or from scanned-in paper records with optical character recognition (OCR). Patient care data may be recorded directly from electronics including devices, sensors, monitors, and technologies used by a patient to communicate a need or activity either physically (i.e. via push of button, movement, etc.) or physiologically (i.e. from a cardiac or other monitor). Location and movement data may be extracted from sensors, monitors, and/or other various readers included in a data table.

Data may be fed to the system from databases of outside sources such as labs and imaging centers. Further, health and/or behavior data can be collected from wearables, such as a pedometer, activity tracker, blood pressure cuff, or diabetic monitor, illustrated in FIG. 1 as element 140. Such “wearables” may be in the form of an application running on an electronic device worn or carried by the patient, such as a dedicated activity tracker (e.g., a FITBIT or VIVOFIT) or a mobile device, such as a smartphone. Data from wearables may be periodically collected from a web-based cloud. Further yet, data may be transmitted to the system from larger medical appliances such as infusion pumps, ventilators, treadmills, electronic scales, and other health measurement and improvement machines. Embodiments of the invention may be communicatively coupled with and draw data from facility-wide structures, such as nurse call systems, interactive patient beds, and real-time location systems. The above data sources are intended only to be exemplary and are in no way meant to limit the invention. Patient care acquired by any means from any source may be used in the embodiments of the invention.

FIG. 2 illustrates a hospital 202 in which a patient receives care, and other locations 208-214 where the patient may receive further care. All of the patient care data collected during the patient's stay on floor 204 in hospital 202 is stored in a patient care record in server 130 for future use. In embodiments, server 130 may be located in hospital 202, at a remote location, or may comprise a plurality of servers at one or more locations. Patient care data stored in the patient care record is relevant and beneficial to the patient's well-being and satisfaction in all future health care episodes, regardless of whether or not those episodes occur on floor 204 of hospital 202.

For instance, consider an example in which a patient undergoes a surgical procedure on floor 204. Patient care data, including medical data such as vital signs and behavioral data such as attitude and emotional disposition are recorded during the surgical visit and stored in the patient's care record on server 130. Shortly thereafter, the patient is transferred to a different floor of the hospital 206 for post-op recovery and rest. The patient care data from the surgery on floor 204 is crucial for effective care of the patient on floor 206.

Further, the patient care record will be necessary in future visits to locations outside the hospital to provide the highest level of care and lowest risk of harm. For instance, an adverse reaction to a particular anesthetic may be discovered during the surgical procedure on floor 204. Access to the patient care record is vital in future health care episodes to ensure that the patient is not given the anesthetic again, leading to another adverse reaction. Future health care episodes may occur at this first hospital 202, a second hospital 214, an outpatient clinic 208, a long term nursing facility 210, a patient home 212, or any other location where health care may be provided, so providers at each of these locations need access to the patient care record in server 130.

Methods of transferring the patient care record often struggle with security of data and accuracy of patient identification. Embodiments of the invention support access to patient care records stored in a server by transmitting a unique indicium to a mobile electronic device, such as a smartphone, tablet, gaming device, or computer, that the patient may take with them to future episodes. In embodiments, the mobile electronic device receiving the unique indicium for presentation at a future location of care may or may not belong to the patient.

In an embodiment, the unique indicium is correlated at the server 130 with the patient care record. Upon presentation of the indicium on the mobile electronic device at a computing terminal at a health care location, the computing terminal can use information captured from the indicium to request the patient's care record from server 130, with no ambiguity as to the record requested. The computing terminal may further make additions or changes to the patient care record, and transmit these back to the server 130 using data captured from the unique indicium. The above example is exemplary, and is not intended as limiting in any way.

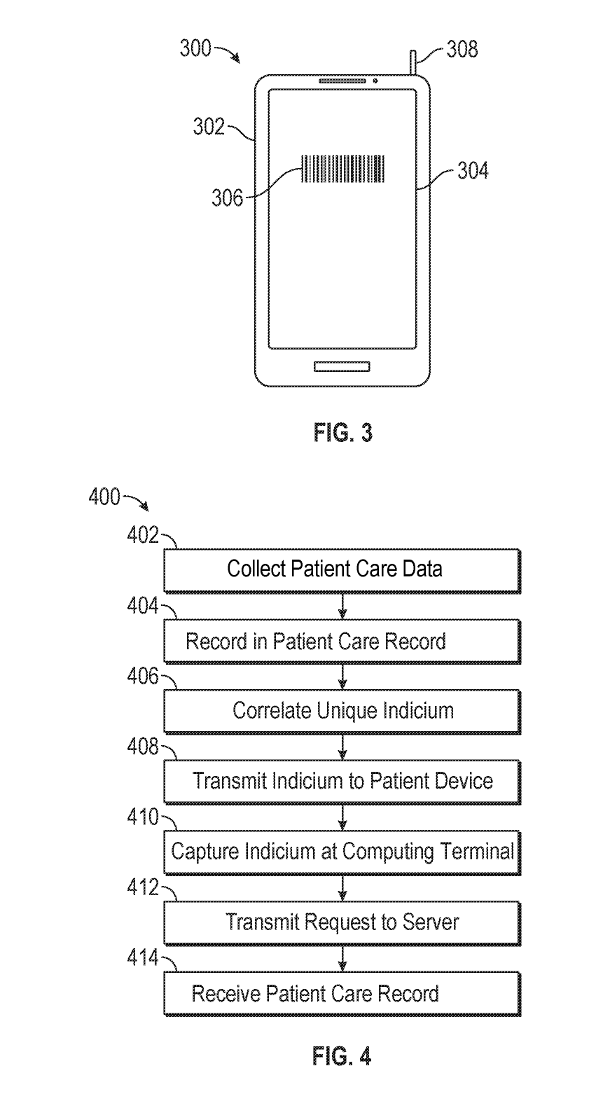

An example of a mobile electronic device is illustrated in FIG. 3 as a smartphone 302. In the illustrated embodiment, a unique indicium 306 correlated with the patient's care record on a server 130 has been transmitted to a memory of smartphone 302 via a communication technique such as text message or email. This is intended as an example; in some embodiments indicium 306 may be received and/or transmitted to/from smartphone 302 via an antenna 308. Antenna 308 may, of course, be internal to smartphone 302.

Unique indicium 306 is displayed on a display screen 304 of smartphone 302 for presentation to an indicium receiver 119 such as a barcode scanner at a computing terminal, as described above. In embodiments, the barcode indicium 306 may correspond to the full name, birthday, and/or medical record number (MRN) of the patient. In other embodiments, for security purposes, the indicium 306 may include no personally identifiable information, either explicitly or in barcode notation. Specifically, the indicium 306 may correspond to an alphanumeric string procedurally generated by server 130 at correlation of the indicium with the patient care record.

Unique indicium 306 may be presented on the display of smartphone 302 in response to input by a patient, and may be scanned by an indicium receiver 119 in embodiments. In other embodiments, the indicium may be transmitted to the indicium receiver 119 via a wireless transmission protocol such as Bluetooth, RFID, or other near field communication (NFC) scheme for capture by the computing terminal without visual presentation on display screen 304.

In some embodiments, the computing terminal may transmit a request to a server 130 for the patient care record based at least in part on the indicium automatically and/or immediately upon capture from the mobile electronic device of the patient 302. In other embodiments, the request transmission to the server 130 may be performed in response to a manual input by an operator of the computing terminal, such as a nurse or office administrator at an outside care location 208.

### Operation of Embodiments of the Invention

Illustrated in FIG. 4 is a method that may be stored in computer-executable instructions on a non-transitory computer readable medium according to an embodiment of the invention beginning at step 402, in which patient care data is collected as described above from electronic care devices such as medical appliances, a care provider computing device, wearable monitoring devices, or a care facility structure such as a nurse call system. This is not intended as limiting, as the patient care record may contain any information relevant to the care of the patient, in embodiments.

In step 404, the collected and/or generated patient care data is recorded in a patient care record linked to the personal identity of the patient on a server 130. The server may be a plurality of servers located at any location, such as a cloud server housed partially or entirely at a non-medical care facility. Particularly, the server 130 may be included in a local network with the electronic care device 140 that collected the patient care data.

At step 406, the server 130 and/or processor 106 correlates a unique indicium such as a one-dimensional barcode, two-dimensional barcode, or alphanumeric code with the patient care record. In embodiments, indicia used may be prescribed, randomly generated, and/or procedurally generated by the server 130 and/or processor 106. The correlation between the indicium and the may be stored in the server 130 as well and/or in another correlation server. In some embodiments, the correlation between the unique indicium and a patient care record may expire after a given amount of time, such as three days. This valid period of the indicium may be stored in the server 130, and may begin at the point of generation of an indicium or at the moment of transmission to a mobile electronic device of a patient. In some embodiments, the indicium may additionally or alternatively have a valid number of uses. For example, and indicium may be used to request transmission of a patient's care record two times, after which the indicium is uncorrelated from the patient's care record in the server 130.

At step 408, the unique indicium is transmitted to a mobile electronic device of a patient through a method such as email, SMS text message, or a physical transferrable computer-readable medium such as a SIM card. In some embodiments, a wire such as a USB cable may be connected between the computer 102 and mobile electronic device for transmission of the unique indicium at step 408. In embodiments, the indicium may be transmitted and/or received through a dedicated application operating on the computer 102 and/or the mobile electronic device of the patient. In embodiments, the mobile electronic device may or may not belong to the patient. The device can be carried by the patient to a location within or outside the care location at which the patient care data was recorded to facilitate secure request and transmission of the patient's medical and behavioral history.

In some embodiments, the patient carries the mobile electronic device, such as their cell phone, to a second hospital 214, an outpatient clinic 208, a long term nursing facility 210, or any other location of care. In some embodiments, the computing terminal may be a personal computer in the home of the patient, a family member of the patient. and/or any other private residence where the patient wishes to receive their patient care record. Specifically, in some embodiments, may be external to the local network connecting the electronic care device 140 and the server 130.

In step 410, at least a portion of the indicium 306 is captured by an indicium receiver communicatively coupled to the computing terminal, such as a barcode scanner or digital camera. In some embodiments, the indicium receiver may be provided as hardware facilitating a wireless communication protocol, enabling an electronic “handshake” for transfer of data from the mobile electronic device to the computing terminal. In other embodiments, the indicium may be an alphanumeric code, simply input by a user such as an employee of a patient care facility via a keyboard 118 or other input device.

At step 412, the computing terminal transmits a request to the server based at least in part on the indicium. In some embodiments, this may comprise the entire indicium, while in others the request may include only a portion of the information carried by the indicium along with, possibly, additional information added by the computing terminal. In some embodiments, the computing terminal coupled to the indicium receiver may transmit this request automatically, possibly upon capture of the indicium via a network interface card 124. In embodiments, the computing terminal may be a self-service kiosk, operated by the patient or assistant to the patient.

Finally, in step 414 the computing terminal receives at least a portion of the patient care record stored in the server 130. The patient care record may be transmitted via any means, for instance through an Internet transfer protocol or web portal. In some embodiments, the received patient care record may require input of an authentication key to unlock, unencrypt, or otherwise access the patient care record. In embodiments, this authentication key may be provided electronically or manually to the patient or an assistant of the patient at the time of transmission of the unique indicium to the mobile electronic device of the patient at step 408.

For example, a unique indicium provided as a two-dimensional barcode may be transmitted via a text message to a smartphone belonging to the parent of an adolescent patient as the patient is being discharged from a hospital 202. At this time, the parent may set up an alphanumeric password necessary for unlocking the patient's password in the future, which is input at a computer 102 and stored in a server 130.

Upon a subsequent visit to a second hospital 214, the parent may present the two-dimensional barcode to a nurse, who scans the barcode and receives the patient's care record from the server 130. At this time, the parent must provide the agreed-upon password to allow the nurse at second hospital 214 access to the received patient care record of the adolescent patient.

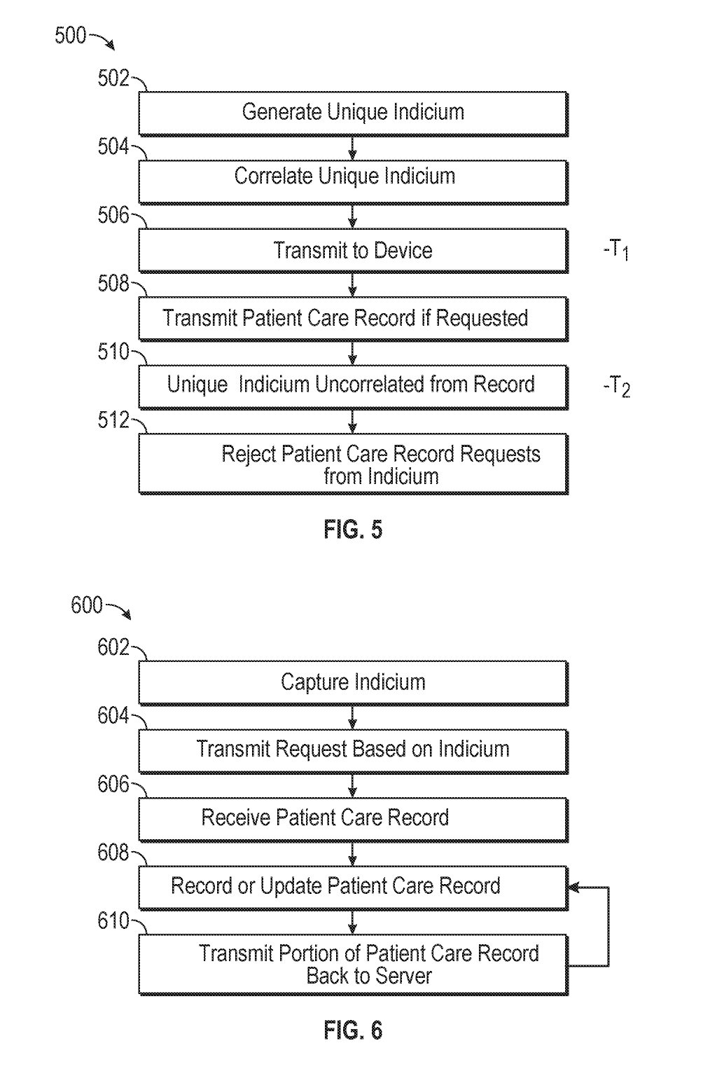

As discussed above, in embodiments of the invention, the unique indicium may be uncorrelated from the patient care record after a prescribed set of circumstances is met. An example of such an embodiment is illustrated in FIG. 5, beginning at step 502 in which a unique indicium is generated. As discussed above, the indicium may be a one-dimensional barcode, two-dimensional barcode, or alphanumeric code. In embodiments, the indicium may be an address of the patient care record on the server 130, as well as an address for the server 130. In some embodiments, a set of unique indicia may be pre-generated and provided to the server 130 and/or processor 106 for correlation with each stored patient care record, or may be generated randomly, sequentially, and/or procedurally by the server 130 and/or processor 106.

At step 504, a unique indicium is correlated with a patient's care record by server 130 and/or processor 106. In embodiments, this correlation is stored in server 130, such as in a table or index, and may be additionally or alternatively stored directly in the patient care record. In other embodiments, the correlation may be stored in a separate correlation server.

Before, during, or after step 504, a condition may optionally be established for uncorrelation of the unique indicium from the patient care record. In some embodiments, this condition for uncorrelation may comprise a time period of validity of the indicium, during which requests based on the indicium will be served and responded to with the patient care record by server 130 at step 508. After expiration of this period in step 510, requests based on that unique indicium will be rejected at step 512, meaning the patient would be required to acquire a new unique indicium.

Additionally or alternatively, the condition for uncorrelation may include a threshold number of requests for a given patient care record that will be server and responded to with the patient care record by server 130. As before, after this threshold number of requests have been responded to, the unique indicium will be uncorrelated from the patient care record at step 510 and further requests based on that unique indicium will be rejected at step 512, meaning the patient would be required to acquire a new unique indicium.

In some embodiments, the patient care record may be adjusted, extended, revised, or otherwise updated at the second location of care, whether or not the second location of care is in the first hospital 202. An example of such an embodiment is illustrated in FIG. 6, beginning in step 602 in which a unique indicium is captured at a computing terminal at the second location of care. As discussed above, in embodiments, this computing terminal may be a computer 102 or self-service kiosk at a facility such as an outpatient clinic 208, a long term nursing facility 210, hospital 202, or a second hospital 214, or maybe a personal computer at patient home 212. These examples are not intended as limiting.

At step 604, a processor 106 of the computing terminal transmits a request to server 130 based at least in part on the captured indicium. In some embodiments, this may include a patient identifier scanned from the indicium and/or may include a network address for reception of the request or retrieval of the patient care record. The server 130, in response to reception of the request from step 604, identifies, retrieves, and transmits the patient care record for the given patient. At step 606, the patient care record is received back at the computing terminal.

At step 608, information contained in the patient care record is changed, replaced, extended, adjusted, or otherwise updated from that which was received. In step 610, the updated patient care record is transmitted back to the server 130 for storage and/or updating of the original record. In some embodiments, only a portion of the patient care record updated may be returned, while in other embodiments the entire record may be sent.

The method may then return to step 608, changing, recording, or updating additional patient care data in the patient care record, and may be once again transmitted back to the server at step 610. The transmissions may, in embodiments, be periodic and/or automatic upon extension or adjustment of the patient care record.

For example, a dentist office may input an alphanumeric code from an email on a patient's mobile electronic device to a computer 102. The computer then transmits a request to the server 130 including the alphanumeric code, which corresponds to a patient care record for that patient in a correlation table stored separately. The server 130 looks up the alphanumeric code in the correlation table, locates the corresponding patient care record, and transmits it back to the computing terminal at the dentist office.

Thereafter, the dentist may perform oral surgery and record vital signs, medications used, reactions of the patient, or other care data. When the surgery is complete, the computing terminal may transmit the updated patient care record back to the server 130 along with the alphanumeric code previously captured. The server 130, upon receiving the updated patient care record, may once again consult the correlation table, and replace or update the previous patient care record with the new record received from the dentist office. In some embodiments, the server 130 may then transmit a message to the computing terminal indicating successful update of the patient care record.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for managing patient care data, the system comprising:
an electronic care device configured for collecting patient care data communicatively coupled to a local network;
a server communicatively coupled to the electronic care device,
wherein a set of patient care data collected by the electronic care device is recorded in a patient care record stored in the server,
wherein the patient care record is uniquely correlated with an indicium;
a computing terminal external to the local network; and
a scanning device communicatively coupled to the computing terminal,
wherein the scanning device captures the indicium from a mobile electronic device of the patient,
wherein the computing terminal transmits a request to the server based at least in part on the indicium, and
wherein the server, in response to the request, transmits the patient care record to the computing terminal.

2. The system of claim 1, wherein the scanning device is selected from a group consisting of a barcode reader and a digital camera.

3. The system of claim 2, wherein the indicium is a barcode, and wherein the mobile electronic device presents the barcode on a display screen for capture by the scanning device.

4. The system of claim 1, wherein the electronic care device is selected from a group consisting of a medical appliance, a care provider computing device, a wearable monitoring device, and a care facility structure.

5. The system of claim 1, wherein the computing terminal is a workstation operated by an employee of a patient care facility.

6. The system of claim 1, wherein the computing terminal is a self-service kiosk.

7. The system of claim 1, wherein the computing terminal is a personal computer.

8. The system of claim 1, wherein the indicium is transmitted to a mobile electronic device of the patient via email.

9. The system of claim 1, wherein the indicium is transmitted to a mobile electronic device of the patient via text message.

10. A method of managing patient care data, the method comprising the steps of:
collecting patient care data from an electronic care device,
wherein the electronic care device is communicatively coupled to a local network;
recording patient care data in a patient care record,
wherein the patient care record is stored in a server communicatively coupled to the local network;
correlating a unique indicium with the patient care record;
transmitting the indicium to a mobile electronic device of the patient;
capturing the indicium at a computing terminal,
wherein the computing terminal is external to the local network;
transmitting a request from the computing terminal to the server based at least in part on the indicium; and
receiving the patient care record at the computing terminal.

11. The method of claim 10, wherein the unique indicium is selected from a group consisting of a one-dimensional barcode, a two-dimensional barcode, an alphanumeric string, and a network address.

12. The method of claim 10, wherein the step of transmitting the indicium to the mobile electronic device is performed using a communication technique selected from a group consisting of a Bluetooth connection, an infrared connection, a text message, and an email.

13. The method of claim 10,
wherein the step of transmitting the indicium to a mobile electronic device of the patient is performed at a time T₁, and
wherein, at a time T₂, the indicium is uncorrelated from the patient care record by the server.

14. The method of claim 10, further including the step of providing the patient with an authentication key for authenticating the indicium transmitted to the computing terminal.

15. The method of claim 10, wherein the indicium is uncorrelated from the patient care record after a threshold number of requests for the record have been received by the server.

16. A system for managing patient care data, the system comprising:
a processor;
a network interface card;
an indicium receiver; and
a non-transitory computer readable medium storing computer-executable instructions which, when executed by the processor, perform the steps of:
capturing an indicium via the indicium receiver,
wherein the indicium corresponds uniquely to a care record for a patient, and
wherein the indicium is presented via a mobile electronic device of the patient,
transmitting, via the network interface card, a request based at least in part on the indicium to a server containing the patient care record, and
receiving the care record of the patient from the server.

17. The method of claim 16, wherein the indicium is free from any personally identifiable information.

18. The system of claim 16, wherein the step of capturing the indicium via the indicium receiver is performed using a wireless transmission protocol.

19. The system of claim 16, wherein the computing terminal transmits the request to the server automatically upon capturing the indicium via the indicium receiver.

20. The system of claim 16, wherein the computer-executable instructions further perform the steps of:
transmitting at least a portion of the patient care record back to the server,
wherein the portion of the patient care record transmitted includes an updated set of patient care data.
